(19) United States
(12) Patent Application Publication
(10) Pub. No.: US 2017/0072857 A1
(43) Pub. Date: Mar. 16, 2017

(54) DISPLAY DEVICE FOR SELF-PROPELLED INDUSTRIAL MACHINE

(71) Applicant: HITACHI CONSTRUCTION MACHINERY CO., LTD., Tokyo (JP)

(72) Inventors: Yoichi KOWATARI, Kasumigaura (JP); Yoshihiro INANOBE, Kasumigaura (JP); Katsuhiko SHIMIZU, Tsuchiura (JP); Hidefumi ISHIMOTO, Toride (JP)

(21) Appl. No.: 15/343,665

(22) Filed: Nov. 4, 2016

Related U.S. Application Data
(63) Continuation of application No. 14/404,652, filed on Dec. 1, 2014, now abandoned.

(30) Foreign Application Priority Data
Jun. 8, 2012 (JP) 2012-130724

(51) Int. Cl. B60R 1/00; G06T 11/60; G06K 9/00; H04N 7/18; B60R 11/04; B60P 1/04

(52) U.S. Cl. CPC B60R 1/00; B60R 11/04; B60P 1/04; G06K 9/00791; H04N 7/181; G06T 11/60; B60R 2300/105; B60R 2300/303; B60R 2300/607; B60R 2300/802; B60Y 2200/142; E02F 9/26

(57) ABSTRACT

The underneath image of a self-propelled industrial machine is displayed with as wide a range as possible on a monitor with cameras that take images around the self-propelled industrial machine in the form of bird's eye view images. A view point conversion section creates the bird's eye view image by converting images from plural cameras provided on a dump truck; and a superposing process section processes the images to make the underneath area in a symbol image a transparent region corresponding to the position in the bird's eye view. An image composing section sets the symbol image at the center position and the respective bird's eye view images around the symbol image. A monitor displays the composite image composed by the image composing section.

### CROSS REFERENCE TO RELATED APPLICATION

This application is a continuation of U.S. application Ser. No. 14/404,652, filed Dec. 1, 2014, the entirety of the contents and subject matter of all of the above is incorporated herein by reference.

### FIELD OF THE INVENTION

The present invention relates to display device for self-propelled industrial machine to assist on traveling operation of self-propelled industrial machine, such as dump truck, hydraulic excavator and the like.

### DESCRIPTION OF THE BACKGROUND ART

A self-propelled industrial machine works in various field of working sites. A dump truck is an example of the self-propelled industrial machine. The dump truck has a loading platform (vessel) adapted to move up and down on a vehicle body frame, the vessel is adapted to load objects such as crushed stones, earth and sand, etc. Then, the dump truck travels to a collection yard for the sake of discharging the loaded objects. The dump truck goes backward and is stopped at a discharging area. After completion of discharge out of the loaded objects, the vessel is returned to the original position and the dump truck is moved forward.

A hydraulic excavator is another type of the self-propelled industrial machine. The hydraulic excavator comprises a traveling base structure having a crawler-type or a wheel-type traveling means and an upper swiveling structure being rotatably placed on the traveling base structure. An operation chamber (cab) is mounted on the upper swiveling structure, and also provided on the upper swiveling structure is a working mechanism which is composed of a boom adapted to cause derricking operation to the upper swiveling mechanism, an arm being connected in vertically rotatable manner to distal end of the boom, and a bucket for digging earth and sand.

Although an operator boarded in the cab of the self-propelled industrial machine such as the dump truck or the hydraulic excavator can be attained front view, but dead angle regions are generated on the back side, and left and right side views. Due to some directions may hardly be visible with the naked eye of the operator, techniques that a monitor is mounted in the cab and a bird's eye view image is shown on the monitor is disclosed in Patent Document 1.

According to the techniques of the Patent Document 1, three cameras are provided for the sake of surveillance at the back side and, the left and right sides of the hydraulic excavator to keep watch around the hydraulic excavator. The optical axis of respective cameras are directed toward obliquely downward direction to create virtual bird's eye view image for every cameras. Accordingly, three bird's eye view images are prepared to be positioned around an over view image of the complete dump truck 1. Thus prepared bird's eye view image can be displayed on the display so that the operator can clearly watch and understand the situation around the hydraulic excavator. Thus, the operator is assisted for traveling operation.

### PRIOR ART DOCUMENT

### Patent Document

Patent Document 1: JP 2012-74929 A1

### SUMMARY OF THE INVENTION

### Problem to be Solved by the Invention

In the self-propelled industrial machine, a monitor disposed in a cab to be displayed around the hydraulic excavator, thereby adapted to display on a screen the area of dead angle by the naked eye of the operator, as a result advantageous for understanding the situation of around the self-propelled industrial machine. Therefore, the technique of Patent Document 1 exhibits very excellent results.

While, area of dead angle for the operator remains not only in surroundings of the self-propelled industrial machine but also at the underneath thereof. The self-propelled industrial machine will be restricted to travel in a case where some obstacle exists under the self-propelled industrial machine. For example, as to a dump truck, the dump truck is restricted to travel after loading works of earth and sand, if an obstacle is presented under there.

Generally, as a dump truck, in addition to a normal dumper, a large scaled dump truck to be activated, is formed a wide space at the lower side thereof. Specifically, the lower side of such a heavy dump truck as having a load weight over 100 t is formed further broader space. Therefore, an obstacle may be entered into the lower portion of the dump truck. Such situation causes to bring limitation for traveling of the dump truck in consideration of safety. The similar situation is caused for another type of the self-propelled industrial machine such as a hydraulic excavator or the like of which has a lower traveling structure. Therefore, although it is important to grasp the situation around the self-propelled industrial machine, the operator should also pay the attention to recognize about the lower situation.

Since the cameras mounted to the self-propelled industrial machine are directed the optical axis to obliquely downward direction for displaying the bird's eye view image, some underneath areas of the self-propelled industrial machine are included into the image depending upon the mounting position of the camera. Accordingly, the underneath situation of the self-propelled industrial machine can be recognized by displaying the underneath image partially involved in the field of view on a monitor.

However, the cameras for creating the bird's eye image is only for those which take image of around the self-propelled industrial machine, but they are not exclusively use for taking the underneath image of the self-propelled industrial machine. Accordingly, if the self-propelled industrial machine is entered, the reproduced image will appear at only limited area. Although limited area, it is very useful to display the underneath image on the monitor.

Therefore, the object of the present invention is to extend a field of view for underneath area of a self-propelled industrial machine at the time of displaying a bird's eye image around the self-propelled industrial machine taken by cameras.

### Means for Solving the Problem

In order to solve the foregoing problem, a display device for self-propelled industrial machine of the present invention comprises: a plurality of cameras mounded for the self-propelled industrial machine, having the optical axis directed to obliquely downward direction, for imaging around the self-propelled industrial machine; a view point conversion section for converting camera images taken by respective cameras to upper view point to create bird's eye images; a superposing process section to display the bird's eye images and a symbol image of a vehicle body symbolized the self-propelled industrial machine on a monitor, further to superpose underneath images of the self-propelled industrial machine attained from the cameras with a predetermined transparent ratio as a transparent region in the symbol image; a image composing section to display a composite image of the symbol image in the form of discriminating between the transparent region and non-transparent region in the bird's eye view image; and a monitor device provided in a operator's cab of the self-propelled industrial machine for displaying the composite image created in the image composing section.

At the time of displaying the symbol image of the vehicle body and the surrounding bird's eye view image on the monitor, the display device can show the area within the symbol image of the vehicle body to discriminate between a transparent region which is the area behind the vehicle body but taken image in the bird's eye image and a non-transparent region which is not transparent through the vehicle body. The manner of display to discriminate may be written as a boundary line in order to divide into a the transparent region and the non-transparent region, or may be displayed with differential tone between the transparent region and the non-transparent region. Otherwise, coloring may be made for either the transparent region or non-transparent region.

Although normally should be entered into a field of angle, the field of angle is sometimes obstructed partially by the presence of vehicle components, depending upon relative position of the disposition of the camera and the vehicle components. In such a case, the area is shown in different color from the other area as dead angle region.

The transparent region can maximally be utilized by setting criterion between the transparent region and the symbol image region. Thus, the transparent region is shown widely of the underneath image.

Further, in a case where the subjected camera is the back side camera, the boundary line can be set the criterion at the rear end of the self-propelled industrial machine.

The underneath image is attained for the back side camera. The back side camera does not include forward from the rear end of the traveling mechanism, therefore the underneath image can be displayed widely by forming the boundary line as a standard for the rear end of traveling mechanism of the symbol image.

Further, the camera is provided for the rearmost end of a frame of the carrier vehicle, at the higher and rear position of the rear wheel of the vehicle in an extent not contact with the vessel of the carrier vehicle.

The underneath area of the carrier vehicle can show widely image by a back side camera which is mounted on the carrier vehicle at the position upper than the rear wheel. Further, obstruction factor for maximum field of view (mainly rear wheel) can be excluded by providing the back side camera at the rear position than the rear wheel, thereby the underneath image being widely displayed.

The display image may be shown on the display device at the time of traveling operation section for traveling the carrier vehicle to backward direction.

A wide space is formed at the rear side of under the vessel of the carrier of the vessel, thus being liable to enter obstacle substance into the space. Accordingly, the operator can recognize in a facilitated manner to the situation of the under the vessel, by displaying the underneath of the vessel at the time of operating to travel backward direction.

Further, the display area of the display device can be divided in order to show the image created by the foregoing image composing section and the camera image showing the underneath image in the plurality cameras.

Further, the display area of the display device can be divided in order to show the image created by the foregoing image composing section and the camera image showing the underneath image in the plurality cameras.

The bird's eye view image and the camera image may be simultaneously displayed, thereby the underneath image can be recognized from the bird's eye view image and the underneath view image can directly be recognized from taking image of the corresponding camera.

### Effects of the Invention

According to the present invention, a transparent region can be widely utilized by displaying a symbol image partially as an transparent image, on displaying to a monitor of a bird's eye image in the symbol image of a self-propelled industrial machine. Therefore, an underneath image can widely be displayed on a transparent area.

### BRIEF DESCRIPTION OF THE DRAWINGS

FIG. 1 is a left side elevation view of a dump truck.

FIG. 2 is a plane view of the dump truck.

FIG. 3 is a drawing of an example of a monitor to be mounted in a cab.

FIG. 4 shows a block diagram of a display controller.

FIG. 5 shows an embodiment of a principle of a method for treating a view point conversion.

FIG. 6 shows an example of displayed image on a monitor screen.

FIG. 7 is an example shown superposed an underneath image in FIG. 6.

FIG. 8 is an example of display image at the time of bringing a dead angle into existence.

FIG. 9 is another example of FIG. 6 to differentiate the boundary line.

FIG. 10 is an illustrative drawing showing to display dividedly into a bird's eye view image and a camera image.

FIG. 11 is a drawing illustrated the rear part of a dump truck.

FIG. 12 shows the rear part of the dump truck in a state removed the vessel.

FIG. 13 shows a left side view of a hydraulic excavator.

### EMBODIMENT OF THE INVENTION

Hereafter, embodiments of the present invention will be described with reference to the attached drawings. As self-propelled industrial machine, carrier vehicle, construction machine, roadwork vehicle and the like are included, a dump truck is a typical carrier machine and a hydraulic excavator is a typical construction machine. In this embodiment, a dump truck is explained hereafter, but the other self-propelled industrial machine may be adapted other than the dump truck. The dump truck 1 includes a rigid type and an articulated type, any type can be applied. In the embodiment, “left” means the left side view from an operator's cab, and “right” means the right side view from the operator's cab.

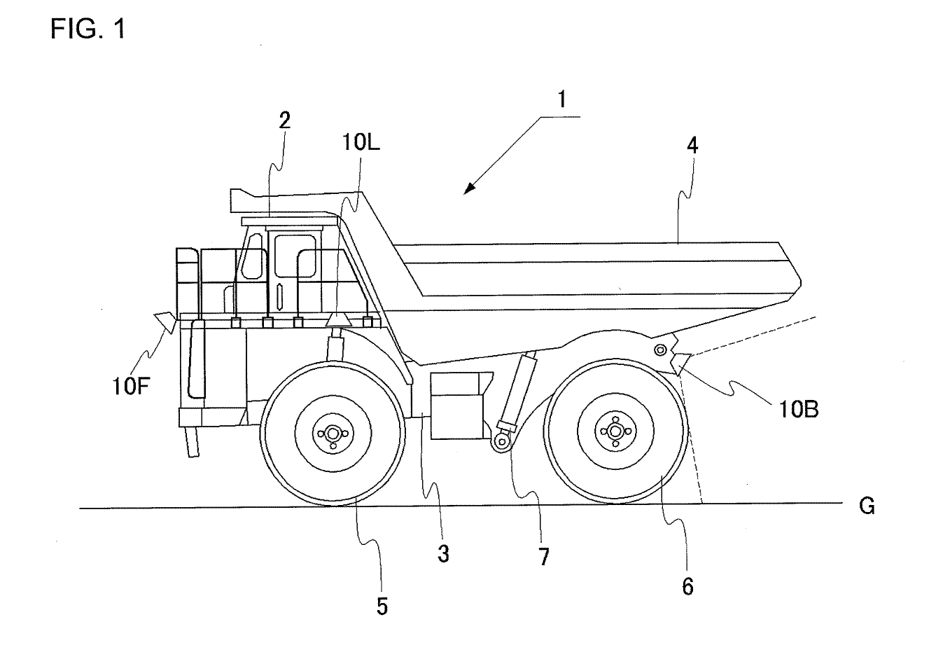

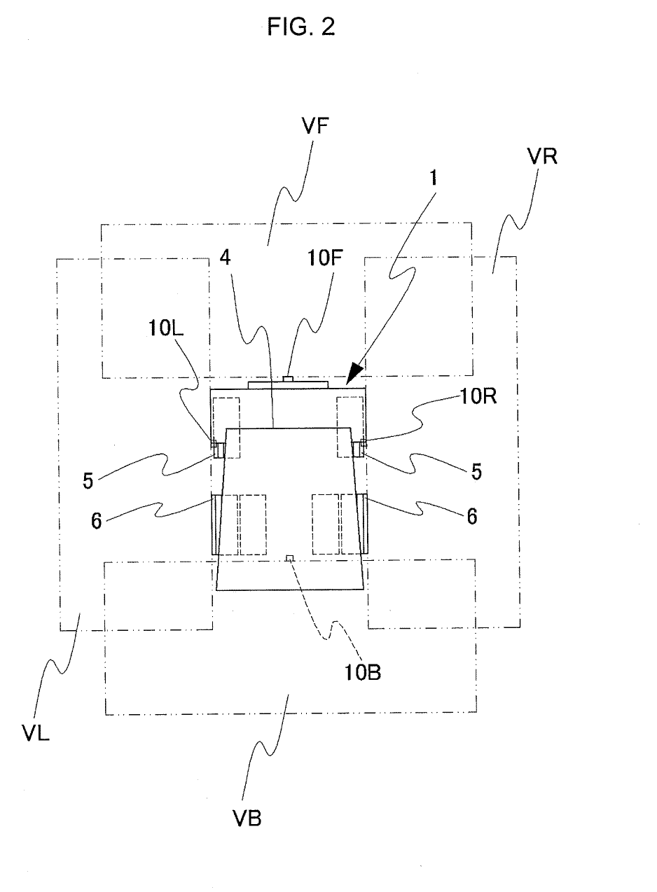

FIG. 1 shows the left side elevation of the dunk truck 1 and FIG. 2 shows the plan view thereof. As shown in these drawings, the dump truck 1 comprises an cab 2, a frame 3, a vessel 4, front wheels 5 and rear wheels 6, a driving cylinder 7 and a link mechanism 8. The front, rear, left side and right sides of the dump truck 1 are provided with cameras 10 as around imaging devices (front side camera 10F, right side camera 10R, left side camera 10L and back side camera 10B), and images taken by respective cameras are outputted as camera images. The dot line is shown as a field of view for the back side camera 19B

The front side camera 10F has a field of view toward the forward side, the back side camera 10B has a field of view toward the backward side, the right side camera 10R has a field of view toward the right side and the left side camera 10R has a field of view toward the left side. In FIG. 2, phantom lines are indicated respectively for the view area of the front side camera 10F as a forward view region VF, for the view area of the back side camera 10B as a backward view region VB, for the view area of the right side camera 10R as a left side view region VL and for the view area of the right side camera 10L as a right side view region VR. These view regions are exemplified as rectangular form, but not restricted to be rectangular form.

These cameras take image around the dump truck 1 and these cameras are directed obliquely downward direction. In this connection, number of cameras 10 may be arbitrary to be mounted on the dump truck 1. While, it is desired to provide that the back side camera 10B, the right side camera 10R and the left side camera 10L are mounted at respective positions toward the directions possibly causing dead angle for the operator. In a case of an articulated type dump truck, further more cameras may be provided.

A cab 2 is provided for boarding the operator to operate the dump truck 1 is normally placed at the left side at the dump truck 1. Various operating means are arranged in the cab 2. The frame 3 constitutes a truck frame, the front wheel 5 is provided at the fore side of the frame 3 and the rear wheel 6 is provided at the rear side thereof. The vessel 4 is a platform which is loaded with earth and sand, ore or the like. The vessel 4 is connected to the driving cylinder 7 and the link mechanism 8 for tilting action. Thereby, loaded earth and sand or the like is discharged out from the vessel 4.

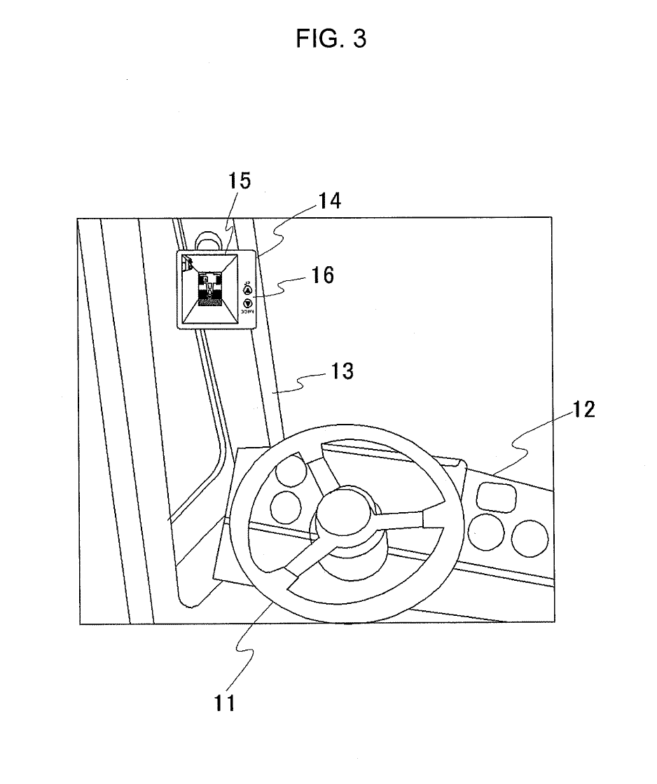

FIG. 3 shows an example of the cab 2. A handle 11 for performing operation of the driving direction and indicators for various meters are provided on a consol 12 and pillars 13 are installed in the cab 2. In addition, a monitor 14 is installed to one of the pillar 13. The monitor 14 is a display device consisting of a screen 15 and an input part 16. The screen 15 shows predetermined information. Further, the monitor 14 is provided arbitral position within the cab 2. Furthermore, the screen 15 may be constituted as a touch panel so as to eliminate the input part 16.

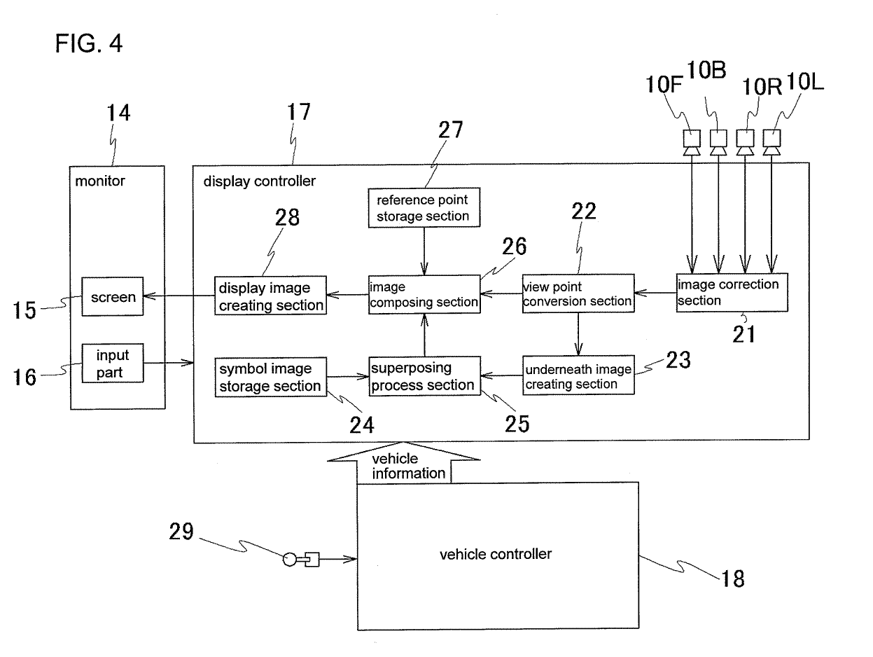

FIG. 4 shows a display controller 17 connected to the monitor 14 and a vehicle controller 18 connected to the display controller 17. As shown in this figure, the display controller 17 comprises an image correction section 21, a view point conversion section 22, an underneath image creating section 23, a symbol image storage section 24, a superposing process section 25, a image composing section 26, a reference point storage section 27 and a display image creating section 28. The respective sections of the display controller 17 may be achieved by a software and the functions of the respective section on the basis of CPU.

The image correction section 21 is inputted image data from the front side camera 10F, the back side camera 10B, the right side camera 10R and the left side camera 10L. And, the inputted image data are subjected to perform various image corrections such as aberration correction, contrast correction, color tone correction and so on based upon parameters for camera optical system and the like. Thereby, the inputted image can be improved the image quality. The corrected image in the image correction section 21 is inputted to the view point correction section 22 as an image data to be subjected for conversion.

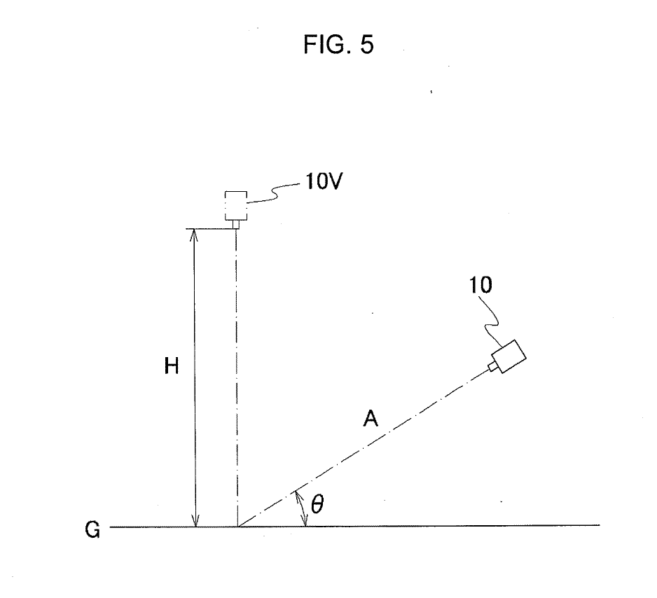

The view point conversion section 22 performs a process for the view point conversion for the image data which is entered from the image correction section 21 to create bird's eye view image (virtual view point image). As described hereinbefore, respective cameras 10 are directed the optical axis to obliquely downwardly for making conversion to virtual view point from upper position to downwardly. As shown in FIG. 5, the optical axis A of objective lens of cameras 10 (front side camera 10F, right side camera 10R, left side camera 10L and back side camera 10B) have a predetermined angle θ with respect to the grand lever L, therefore the optical axis of the cameras 10 are directed obliquely downwardly. According to the view point conversion section 22, virtual camera 10V is virtually set at height H with the vertical optical axis, and the coordinate is converted to view from the virtual camera 10V to the ground surface level G. The image which is converted to the upper view point is virtual plan view (bird's eye view image).

As shown in FIG. 4, the bird's eye view image converted the view points by the view point conversion section 22 is outputted to the underneath image creating section 23 and the image composing section 26. The underneath image creating section 23 creates bird's eye view image of under portion of the dump truck 1, in a case where including a sight of underneath area in the bird's eye view image taken by the camera 10.

In this connection, all cameras are not necessarily involve into the underneath field. Accordingly, underneath image is not created for the camera 10 with respect to not including underneath area of the dump truck 1. In this example, the image of the back side camera 10B is only included the underneath of the dump truck 1 so that the underneath image is created by the camera 10B, but the cameras 10 other than the camera 10B may also be created the underneath image.

The symbol image storage section 24 has a symbol image data. The symbol image is an image of the dump truck 1 to display on the screen 15 as a symbol (character). That is, the symbol image is the reproduction image of the dump truck 1. By making high reproducibility, the operator can exactly recognize the feature of the dump truck 1. However, the reproducibility of the dump truck is not essentially necessary factor.

The superposing process section 25 is inputted the underneath image data from the underneath image creating section 23 and the symbol image from the symbol image storage section 24. The superposing process section 25 transmits light through at the ratio of predetermined transparent degree as a transparent region and makes treatment to process the image to superpose the underneath image on the transparent region. The image processing is carried out the superimposing process (process for duplicate of images), the symbol image and the underneath image is overlaid at the same region, when the transparent ratio is not 100%.

The image composing section 26 is inputted bird's eye view images converted the view point in the view point conversion section 22 together with the symbol image from the superposing process section 25. Then, the superposing is performed to place symbol at the center and the bird's eye view images being arranged therearound. The front bird's eye view image is produced from the front side camera 10F, the rear bird's eye view image is produced from the back side camera 10B and, the left and right side bird's eye view images are produced from the left and right sides cameras 10L and 10R. The composition is performed to allot the symbol image for the center and, to place the front bird's eye image for the fore side, the rear bird's eye view image for the back side, the left side bird's eye view image for the left side and the right side bird's eye view image for the right side.

At this time, the image composing section 26 is read out a reference point from the reference point storage section 27. The composite image consists of the symbol image placed at the center and respective bird's eye view images arranged therearound, further boundary lines being written radially from the symbol image. The boundary lines are set to divide the regions of respective bird's eye view images. The reference point storage section 27 stores the reference points (starting points) at the symbol image for describing the boundary lines. The reference points is set the foregoing transparent regions.

In this connection, 4 cameras are not always provided for front, rear, right and left positions of the dump truck 1. For example, there is the front camera 10F may be omitted. In this case, the front bird's eye view image is not composed due to not be available the front bird's eye view image. In other words, the directions to provided for bird's eye view images are constituted depending upon the directions of cameras 10 to be provided. However, the composite image is preferably included for the dead angle directions left side bird's eye view image, right side bird's eye view image and backward bird's eye view image.

The displaying image creation section 27 creates a single image for display of the composite image of the image composing section 26. The monitor 14 is displayed an image on the screen 15. The operator boarded in the cab 2 can review the displayed image of the screen 15. The screen 15 is displayed not only one single image but also may be displayed plural images by dividing the displaying area of the screen 15 into plural number of split regions.

As shown in FIG. 4, the display controller 17 is connected to the vehicle controller 18. The vehicle controller 18 is connected to various operating means for controlling the dump truck 1. A shift lever 29 is one means to be connected thereto. The shift lever 29 is a travel operating means to control the travel of the dump truck 1, and is adapted to shift three positions of forward position, neutral position and backward position. At the time of the shift lever 29 placed at the forward position, the dump truck 1 runs forward direction, while at the backward position, the dump truck 1 running backward direction and at the neutral position, the dump truck 1 being stopped. The shift lever information as to the status of the position of the shift lever 28 (forward, neutral or backward) is outputted to the vehicle controller 18. Further, the shift lever information is transferred to the display controller 18 as a vehicle information.

By way of the above explained construction, the display image which is shown on the screen 15 of the monitor device 14 is prepared in the display controller 17. Hereinafter it is explained that the bird's eye view image is displayed on the full area of the screen 15, but the screen 15 may be divided into plural areas and the bird's eye view image may be displayed on one of the divided area. The bird's eye view image representation is placed the symbol image at the center position and the bird's eye view images being displayed around (surroundings) the symbol image.

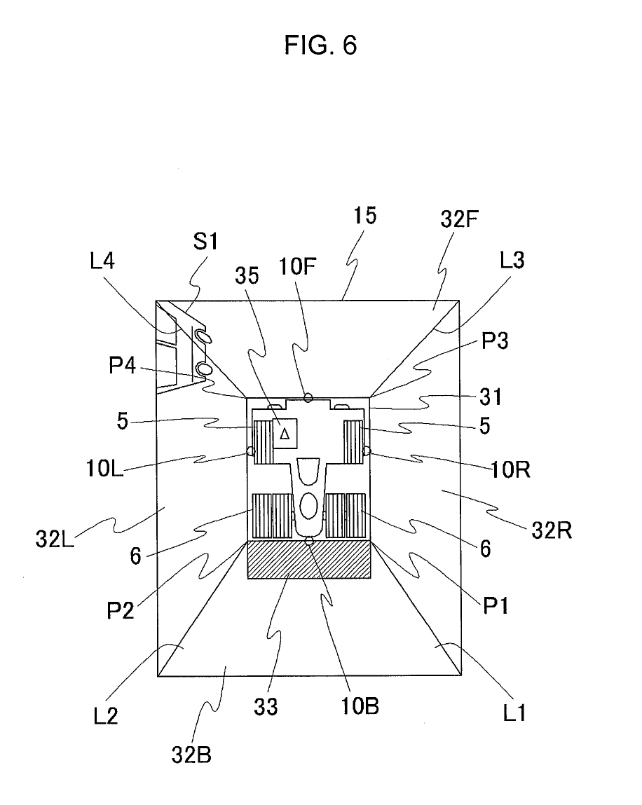

FIG. 6 shows the screen 15 which is formed a rectangular region at the center position of width direction, the symbol image 31 is shown on the center position. The symbol image 31 is, as explained above, a symbol (character) of the contour of the dump truck 1. In a case of the self-propelled industrial machine other than the dump truck 1, the symbol image 31 is, as a matter of course, reproduction of the self-propelled industrial machine. Thus, the symbol image 31 is arranged at the center position and the bird's eye view images being positioned surrounding the symbol image 31.

Boundary lines L1 to L4 are formed toward radial direction from the centrally positioned of the symbol image 31. Thereby, the screen 15 is divided into the fore side, back side, right and left sides regions. The fore side region of the symbol image 31 is displayed the fore side bird's eye view image 32F, the back side region being displayed the back side bird's eye view image 32B, the right side region being displayed the right side bird's eye view image 32R and the left side region being displayed the left side bird's eye view image 32 L. The fore side bird's eye view image 32F, the back side bird's eye view image 32B, the right side bird's eye view image 32R and the left side bird's eye view image 32L are correctively called as bird's eye view image 32.

Respective cameras are performed to make imaging, at least for displaying respective bird's eye view images. The operator operates to start cameras in order to perform imaging by initiating an engine. As explained above, respective cameras 10 take imaging to the obliquely downward direction, that is the front camera 10F is directed to obliquely forward direction, the back side camera 10B being directed obliquely backward direction, the right side camera 10R being directed obliquely right side direction, and the left side camera 10L being directed obliquely left side direction.

The image data from these cameras 10 are outputted (are transferred) to the display controller 17 as camera images. The cameras 10 are taking image continuously at a predetermined cycle and are transferred camera images at every imaging cycle. Thereby, video image is displayed on the screen 15. Also, still image may be displayed.

As shown in FIG. 4, the image correction section 21 performs predetermined correction process to the image data outputted from the cameras 10. Thereby, the quality of the image data can be improved. The image data completed the correction process are subjected to convert the view point in the view point conversion section 22. The image taken from the fore side camera 10F is created the fore side bird's eye view image 32F, the image taken from the rear side camera 10B is created the back side bird's eye view image 32B, the image taken from the right side camera 10R is created the right side bird's eye view image 32R and the image taken from the left side camera 10L is created the left side bird's eye view image 32 L. Thus created bird's eye view images 32 are outputted to the image composing section 32.

Now, an over view image of the dump truck 1 is displayed on the screen 15 as shown in FIG. 6 by displaying respective bird's eye view images 32 around the symbol image 31. This is so-called bird's eye view image representation. The bird's eye view image representation causes to be recognized directly the distance between the dump truck 1 and obstacle S1 for the operator.

For example, the bird's eye view image representation is advantageous in confirming whether or not any obstacle is presented around the dump truck 1, at the time of starting the dump truck 1. It is specifically advantageous to confirm whether an obstacle is approached at the direction of dead angle for the operator. From this reason, the extents of respective bird's eye view images are determined for relatively closed area from the dump truck 1. Namely, cameras as shown in FIG. 5, the angle θ of respective optical axis of the cameras 10 to the ground surface level G is set relatively great angle. Thereby, the situation surrounding of the dump truck 1 can be displayed in the facilitated manner by displaying the bird's eye view image representation as shown in FIG. 6.

From the area indicated with dot line in FIG. 1, the back side camera 10B is the position of under the vessel 4. And the optical axis of the back side camera 10B is directed to obliquely downward direction, whereby the field of angle being included for the under area of the dump truck 1 (vessel 4). Specifically, the broader area under the dump truck 1 enters into the field of view, by setting to large angle θ between the optical axis of the cameras 10 to the ground surface level G and to give wide angle for the back side camera 10B. The underneath area is shown with the bird's eye view image processed by means of the view point conversion and a broad underneath image can be processed by the underneath image creation section 23.

Accordingly, the underneath image of the dump truck is adapted to display on the screen 15 of the monitor 14. The backward underneath image 32B is obtained from the underneath image creating section 23 from the view point conversion section 22. Thus, the underneath image creating section 23 creates the area of under the dump truck 1 in the form of underneath image.

The symbol image storage section 24 is stored the symbol image 31 of FIG. 6 which is reproduced the contour of the dump truck 1. The symbol image 31 of this figure indicates the front wheel 5, the rear wheel 6 and the like, further denotes provision position of the respective cameras 10. The symbol image storage section 24 outputs the symbol image 31 to the superposing process section 25.

The superposing process section 25 makes transparent region 33 at the position corresponding to the underneath image of the symbol image 31. The transparent region 33 is the region added with hatching in the drawing. The position to be mounted, angle of view, direction of optical axis and the like of the back side camera 10B are settled beforehand, thereby the transparent region 33 is known in advance the underneath area in the symbol image 31. Accordingly, the position and the extent of the transparent region 33 has been settled in the symbol image 31. That is, the underneath image (allocated reference numeral as 34) is coincident with the transparent region 33 in the position and extent.

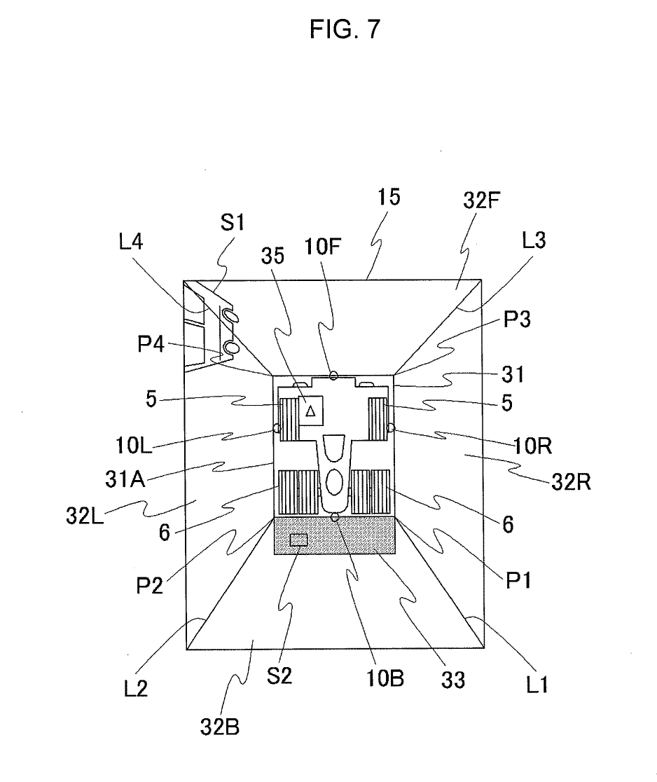

Accordingly, the superposing process section 25 performs to transmit a predetermined transmittance of the transparent region 33 and superposes thereon of underneath image 34 which is attained from the image of the back side camera 10B (superimpose). FIG. 7 shows one example. In this figure, a obstacle S2 is shown. The operator can recognize the presence of the obstacle S2 under the dump truck 1, specifically under the vessel 4 in this case, by viewing the underneath image 34 shown on the screen 15. Under this circumstance, the operator can recognize possibility to contact the rear wheel 6 with the obstacle S2 when the dump truck 1 is driven to backward direction by the operation of the shift lever 29. Accordingly, the operator can aware of being prohibited to change the shift lever 29 to backward position.

As explained hereinbefore, the bird's eye view image representation is shown by processing the conversion of the view point of the images taken by respective cameras 10 (back side camera 10B, right side camera 10R and left side camera 10L). Accordingly, around the dump truck 1 is able to be recognized at a glance. The bird's eye view image representation is the image taken from the virtual view point at upper position over view to the ground surface level G. Thereby, the underneath image of the dump truck 1 cannot be shown in the bird's eye view image due to normally be hidden by the construction such as the cab 2 and so forth.

However, the field of view in the back side camera 10B includes underneath of the dump truck 1. Accordingly, the underneath information as to under the dump truck 1 can be produced in the symbol image 31 by creating the underneath image 34 in the underneath image creating section 23, and then to compose the underneath image 34 on the transparent region 33 by means of the composing process section 25 to make transparent the transparent region 33 of the symbol image 31. In summary, the screen 15 of the monitor device 14 is shown image of the symbol image 31 of the vehicle body and the outside bird's eye image consisting of the back side bird's eye view image 32B and, the right and left side bird's eye view images 32L, in addition, being shown the underneath image 34 in the form of bird's eye view image. In this connection, the symbol image 31 is shown in the manner as partially transparent region. Thereby, the operator can recognize not only around the dump truck 1 and the underneath situation of the dump truck 1 based upon the underneath image in the symbol image 31. While, additional specific camera is not necessary to provide for this purpose due to being utilized the cameras to obtain the bird's eye view image.

As shown in FIGS. 6 and 7, a direction icon 35 is placed at a position of illustrated the cab 2 in the symbol image 31. The direction icon 35 indicates the direction of the operator. In this case, the direction is shown in an arrow of a triangular shape. The direction icon 35 may be adapted to change depending upon the traveling direction of the dump truck 1. For example, in a case where the dump truck 1 travels backward direction, the direction of the arrow turns the opposite direction from the direction as shown FIG. 6.

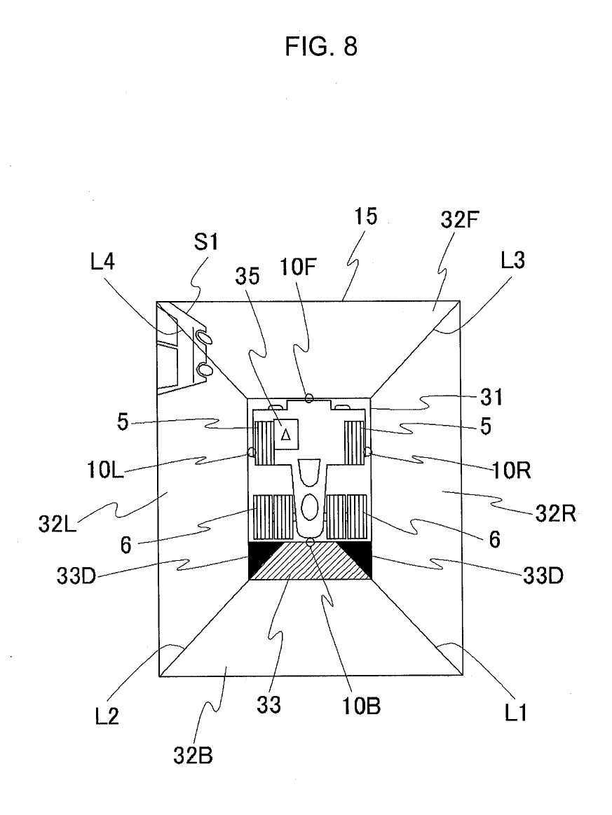

By the way, the image composing section 26 composes images to place the symbol image 31 at the center and to arrange respective bird's eye images 32 to the regions divided by the boundary lines L1 to L4. Normally, the boundary lines L1 to L4 as shown in FIG. 8 are drawn radially from the four vertex (corner) of the rectangular region to be shown the symbol image 31. As shown in FIG. 2, respective image areas VB, VF, VR and VL are partially overlapped with each other, therefore, it stands of a natural fact that the bounder lines are assigned to bring the overlapped areas equally with each other, thus facilitating to simplify the signal process. The bird's eye view images 32F, 32B, 32 L and 32R are displayed in the manner to distinguish from the underneath image 34. The manner for discrimination is exemplified to indicate boundary lines written in symbol image 31 of the vehicle body, but other indication methods may be applied in order to distinguish such as to make the gradation between the transparent region 33 and other area, to provide coloring on one region, and the like.

As shown in FIG. 8, the region between the boundary lines L1 and L2 is shown to display back side bird's eye view image 32B of the back side camera 10B. For this reason, the transparent region 33 in the area between the boundary lines L1 and L2 can be displayed underneath image. Whereas, the leftward area from the boundary line L2 in the transparent region 33 is the area to display the camera image of the left side camera 10L. Further, the rightward area from the boundary line L1 in the transparent region 33 is the area to display camera image of the right side camera 10R.

The left side area from the boundary line L1 in the transparent region 33 has the field of view from the back side camera 10B, but does not include the field of view from the right side camera 10R. Similarly, the right side area from the boundary line L 2 in the transparent region 33 has the field of view from the back side camera 10B, but does not include the field of view from the left side camera 10. Accordingly, two dead angles 33D are generated. These two dead angles 33D are caused that the right side camera 10R and the left side camera 10L do not include in the field of view of the transparent region 33. In other words, underneath image 34 is not shown at the area of dead angle 33D in a case of the boundary lines L1 and L2 indicated from the 4 corners of the rectangular region of showing the symbol image 31.

For this reason, although underneath image 34 of the back side camera 10B is inherently displayed on the full area, a part of the image cannot displayed at the dead angle 33D. In a case where an obstacle S2 is placed in the dead angle 33D, the obstacle S2 is not displayed on the screen 15 although the obstacle S2 is included within the field of view of the back side camera 10B. Accordingly, the area unable to display is, for example, painted in black as the region of the dead angle 33D.

Then, according to the present embodiment, the image composing section 26 composes the symbol image 31 at the center position and respective bird's eye view images around there, and at that time read out reference points P1 to P4 from the reference point storage section 27. The reference points P1 to P4 specify the points to be referred (starting point) in anywhere positions from the contour of symbol image 31 to form the boundary lines L1 to L4.

As shown in FIGS. 6 and 7, the symbol image 31 is originally reproduced character of the dump truck 1 which is prepared in advance. The symbol image 31 has, as shown, the transparent region 33 and can be superposed underneath image 34 on the transparent region 33. Accordingly, the symbol image 31 is divided into the transparent region 33 and other region (symbol region 31A). The symbol region 31A shows a illustration of the character prepared in advance as fixed character. While, the transparent region 33 is constituted inherently of symbol image, but is expressed image to change the contents in accordance with the underneath image 34.

For this reason, the image composing section 26 is, in a case where the region to display the symbol image 31 is a rectangular shape, not the boundary lines L1 to L4 from the 4 corners of the rectangular region, but settled the boundary lines L1 to L4 on the basis of the transparent region 33. In this case, boundary lines L1 and L2 are settled at the border line between the transparent region 33 and the symbol region 31A of symbol image 31. While, the transparent region 31 is not provided for the fore side of symbol image 31, the boundary lines L3 and L4 are set from the corner points of the rectangular portion of symbol image 31. This means, however, that the boundary lines L3 and L4 are almost equal to be set at the corners of the symbol region 31A.

The boundary lines L1 to L4 are determined on the basis of the reference points P1 to P4. The image composing section 26 reads out the reference points P1 to P4 from the reference point storage section 27. The reference points P1 to P4 are set, the area other than the transparent region 33 of the symbol image 31, that is at the 4 corners of the symbol area 31A. Since the transparent region 33 is preset position, the reference points may also be settled beforehand. In other word, it is already known where the reference points P1 to P4 are determined to set on the contour of the symbol image 31.

Then, the reference lines L1 to L4 are prepared from the reference points P1 to P4 in the image composing section 26. As shown in FIG. 7, the boundary lines L3 and L4 are formed at the corner position of the symbol image 31, while the boundary lines L1 and L2 are formed the boundary place of the transparent region 33 and the symbol region 31A but not from the corner of the symbol image 31.

The extent of the transparent region 33 is determined by the size of underneath image 34 included in the image taken by the back side camera 10B. Accordingly, the transparent region 33 are determined by the field of view to take image from the back side camera 10B. Wide field of view can be attained by using a wide-angle lens for the back side camera 10B, thereby view area being able to magnify at maximum. In this case, the size of underneath image 34 and transparent image 33 are also expanded. Whereas, as shown in FIG. 8, in a case where a construction is present to restrict the field of view with the back side camera 10B, the field of view with the back side camera 10B will be narrowed by the construction which is generating a dead angle 33D. The rear wheel 6 is mainly such the construction. It is difficult to exclude the rear wheel 6 from the field of view of the back side camera 10B. As shown in FIG. 7, the image of the rear portion of the rear wheel 6 is really placed at the border line between the transparent region 33 and the symbol region 31A. Thus, the boundary lines L1 and L2 are start from the rear wheel 6.

As explained above, the image composing section 26 composes respective bird's eye view images on the fore, rear, left and right side regions partitioned with the boundary lines L1 to L4 and the symbol image 31, the boundary lines L1 to L4 being formed on the basis of the reference points P1 to P4. The region surrounded by the boundary lines L1 and L2, and the symbol image 31 is shown the back side bird's eye view image 32B. In addition, as shown in FIG. 7, due to the boundary lines L1 and L2 being extended form fore end corners of the transparent region 33, the underneath image is displayed at the full area on the transparent region 33. Accordingly, the operator can recognize the presence of the obstacle S2 clearly.

The boundary lines L1 and L2 are set on the basis of the rear end of the rear wheel 6 in the foregoing case, but being able to set the basis at other than the rear end of the rear wheel 6. Similarly, the boundary lines L1 and L2 are set between the transparent region 33 and the symbol region 31A on the basis of at the reference points P1 and P2, but the reference points P1 and P2 can be shifted to the forward or backward of the symbol image 31, as shown in FIG. 8. The boundary lines L1 and L2 are also shifted from the initial position (reference points P1 and P2) of the boundary lines L1 and L2.

By the way, due to unable for obtaining field of view at the area of be dead angle 33D, the area is painted in black as shown in FIG. 8 so as to express the area not displayed image. In this connection, by shifting the positions of the reference points P1 and P2 backwardly, the area of the dead angle can be eliminated as much as possible. Otherwise, the reference points P1 and P2 are shifted to backward from the symbol image 31. Dead angle is also generated when the reference points are replaced forward direction, as a result of the region to display back side bird's eye image 32B is come into an area which is not included the field of view for the back side camera 10B. In this case, the reference points P1 and P2 may be slightly sifted forwardly provided that slight dead angle can be accepted.

In summary, on the basis of the transparent region 33, by setting boundary lines L1 and L2 accordingly, the dead angle 33D can be minimized on the transparent region 33 and the underneath image 34 can be displayed on the full area of the transparent region 33 for facilitating effective use at maximum. In addition, the region to be dead angle 33D is shown to make distinguish clearly from the other area, thus attaining superior effect in visibility of the operator.

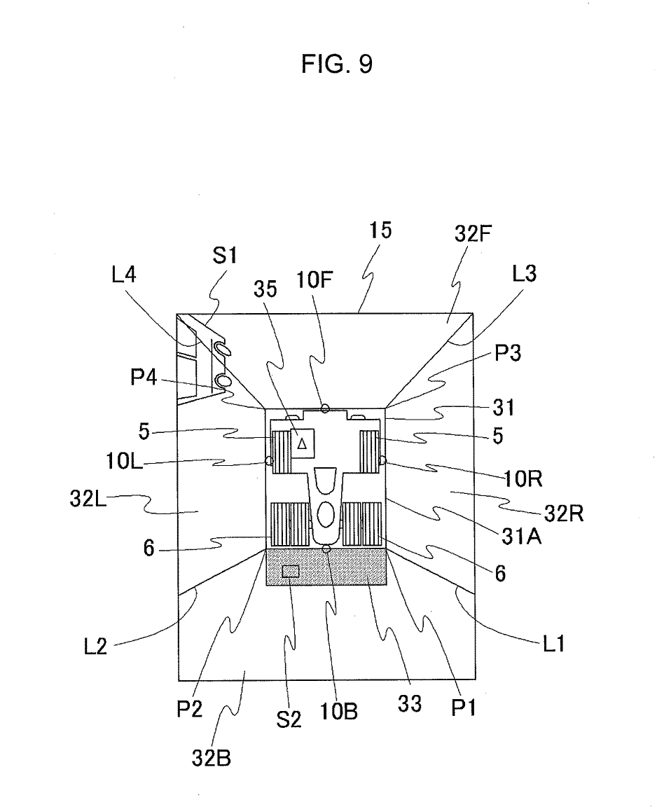

In the embodiment of FIGS. 6 to 8, the boundary lines L1 to L4 are extended at the marginal corners (four corners) of the screen 15, but these are not necessary to direct toward the marginal corners. FIG. 9 shows one example thereof. As apparent from the figure, the lines L1 and L2 are formed apart from the corners of the screen 15. When the back side camera 32B has high pixels and wide angle, priority of display may be given to image of the back camera 32B. For such case, the boundary lines L1 and L2 may be shown as in FIG. 9 depending upon the angle of view of the back side camera 10B.

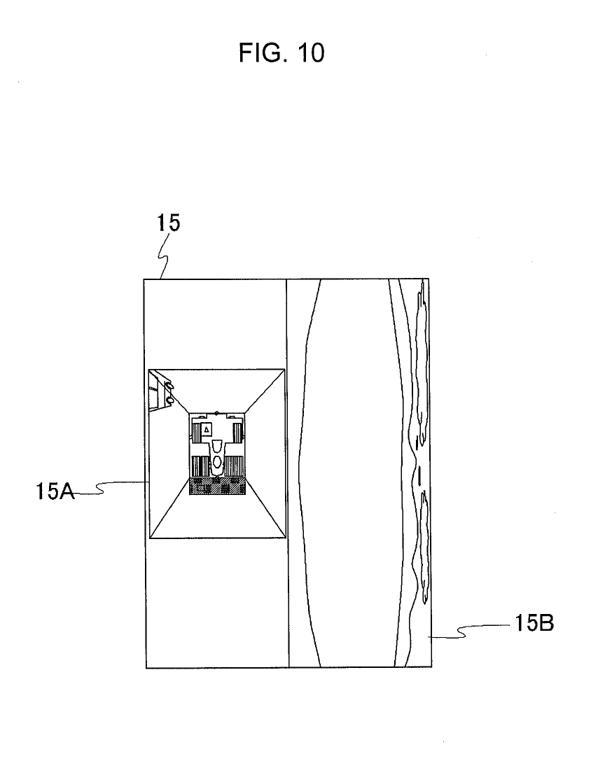

As shown in FIG. 10, the screen 15 may be divided into two parts, the one of divided split part 15A being displayed the composite bird's eye view image, and the other one of split part 15B being displayed camera image of the back camera 10B (image not converted the view point). If an obstacle S2 is placed in the view field of the back side camera 10B, that is displayed in the underneath image 34 on the split part 15A. Camera image of the back side camera 10B is displayed, thereby the operator can more concretely and clearly can recognize the obstacle S2 by looking the split part 15B.

In addition, the example of FIGS. 6 to 10 shows the screen 15 which has more pixels at the transversal direction than the pixels at the horizontal direction, but may be reversed form. Namely, the screen 15 may be long in horizontal direction but not long in vertical direction.

As the boundary lines L1 and L2 are settled on the basis of the back side of the rear wheel 6. This is applicable for the dump truck 1 as the self-propelled industrial machine. In the case of crawler type hydraulic excavator as the self-propelled industrial machine but not the dump truck 1, the boundary lines L1 and L2 is set on the basis of the rear end of the crawler, and in the case of while wheel type hydraulic excavator, is set at the rear end of the rear wheel. In short, the traveling structure to travel the self-propelled industrial machine may be set the boundary lines L1 and L2 on the basis of the rear end thereof.

In a case of dump truck 1, the rear wheel 6 may causes to restrict the field of view to the back side camera 10B, even though wide view field lens is used for the back side camera 10B. To optimize use of the field of view of the back side camera 110B, the back side camera 10B is provided at the rearmost end position of the frame 3 of the dump truck 1. Also, the position is higher than the rear wheel 6 and rear end. However, the back side camera 10B should not be contact with the vessel.

By mounting the back side camera 10B at higher and rear position in comparison with the rear wheel 6, the broader view field can be assured to be included into the underneath area of the dump truck 1 for the back side camera 10B, and the field of view in the back side camera 10B is not restricted by the rear wheel 6. Accordingly, the transparent region 33 can be broadened to a maximum to display broader area of the underneath image 34.

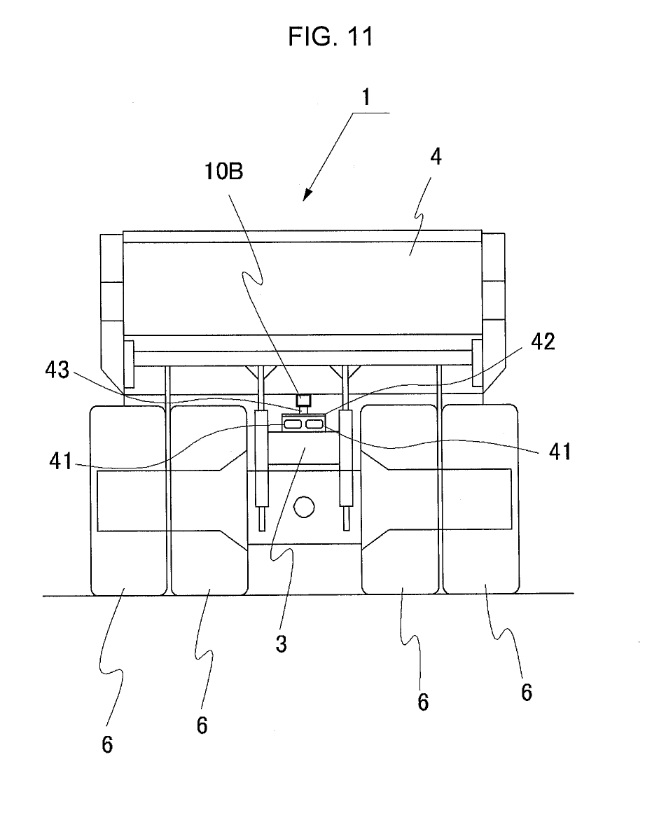

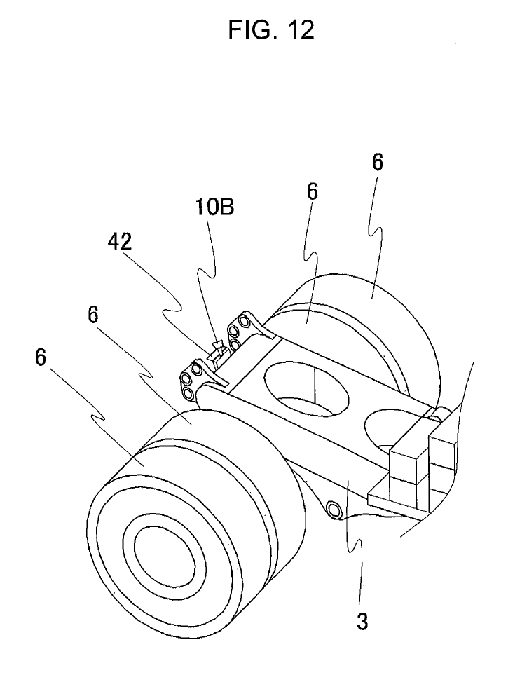

FIGS. 11 and 12 are illustrated one embodiment thereof. As shown in FIGS. 11 and 12, a rear lump 41 is attached at the rearmost position of the frame 3. The rear lump 41 is provided for illuminating the rearward of the dump truck 1. A shield plate 42 is mounted over the position of the rear lump 41. This is to block light from directly enter into the rear camera 10B. A supporting pedestal 43 is mounted upon the shield plate 42, and the back side camera 10B is mounted on the supporting pedestal 43.

As apparent from FIGS. 11 and 12, the back side camera 10B can be mounted over and back side position of the rear wheel 6. Thereby, the field of view from the back side camera 10B is not restricted and can display a wide area of underneath image 34. The operator can, therefore, understand the underneath situation of the dump truck 1 by reviewing the underneath image 34.

As explained, the back side camera 10B can be mounted at desired higher and rearward position than the rear wheel 6, for example, by using a bracket or the like. However, the dump truck 1 travels irregular ground, therefore extreme vibration may be occurred in the course of traveling. Accordingly, the image taken by the back side camera 10B causes to be motion blurred image, greatly.

For this reason, the back side camera 10B is fixed on the frame 3 as a pedestal shown in FIGS. 11 and 12. The frame 3 constitutes a fundamental framework of the dump truck 1, thus facilitating high stability even traveling on irregular ground. Accordingly, the back side camera 10B can take image in a stable situation with causing least blurry.

In the next place, the processing of the image composing section 26 is explained depending upon the traveling operation of the dump truck 1. An operator who is boarded in the cab 2 performs to travel the dump truck 1 by operating the shift lever 29. As explained hereinbefore, the shift lever 29 has forward position, neutral position and backward position, whereby being determined whether or not the dump truck 1 is traveling and, on traveling, forward direction or backward direction depending upon the position of the shift lever 29. Information as to which position is entered of the shift lever 29 (shift lever position information) is inputted to the vehicle controller 18, the vehicle controller 18 being further output of the shift lever position information to the display controller 17.

The superposing process section 25 is also inputted the shift lever information. Thus, the superposing process section 25 recognizes the traveling direction of the dump truck 1. The superposing process section 25 decided whether or not respective transparent regions 34 causes to be transparent on the basis of the shift lever position information, that is the position of the shift lever 29.

When the shift lever 29 enters into the backward position, the dump truck 1 starts to travel backward direction. In a case where an obstacle S2 is placed at the back side transparent region 33, the obstacle S2 may be contacted with the dump truck 1. Accordingly, image processing is carried out to make transparent of the transparent region 33B and the underneath image 34 is composed thereon upon the recognizing to travel the dump truck 1 backwardly.

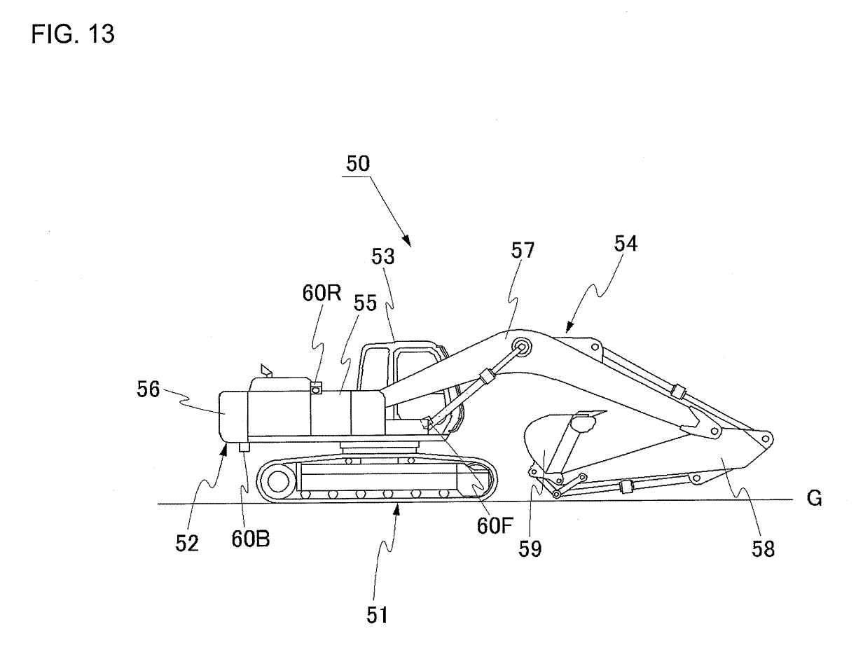

The foregoing is the explanation as to the dump truck 1 for the self-propelled industrial machine, a hydraulic excavator 50 as shown in FIG. 13 is also applied as another type self-propelled industrial machine. The hydraulic excavator 50 consists of a traveling base structure 51 having a crawler type traveling mechanism and a upper swiveling structure 52 connected to the lower traveling base structure 51 adapted to rotate in the horizontal plane. The upper swiveling structure 52 has a cab 53, a working mechanism 54, a machinery housing 55 and a counterweight 56. The working mechanism 54 constitutes a boom 57, an arm 58 and a bucket 59. A normal hydraulic excavator 50 is constructed as generally explained above.

The front side camera 60F, rearward camera 60R, right side camera 60R and left side camera 60L (not shown) are provided for the hydraulic excavator 50. The foregoing cameras are provided for the same object with the front side camera 10F, rearward camera 10R, right side camera 10R and left side camera 10L, for the bird's eye view image representation around the hydraulic excavator 50. The front side camera 60F is mounted in the vicinity of the cab 53, and the rearward camera 60B is under side of the counterweight 56. Further, the right side camera 60R and the left side camera 60L are mounted to the machinery housing 55.

A wide space is formed under the counterweight 56. The rearward camera 60B is taking image of the rearward, the optical axis thereof is directed to obliquely downward direction. Accordingly, the same result as explained to the dump truck 1 is attained by showing the underneath image in the symbol image.

### DESCRIPTION OF REFERENCE NUMERALS

1: dump truck
2: cab
3: frame
4: vessel
5: front wheel
6: rear wheel
10: camera
14: monitor
15: screen
15A: split part
15B: split part
17: display controller
18: vehicle controller
21: image correction section
22: view point converting section
23: underneath image creating section
24: symbol image storage section
25: superposing process section
26: image composing section
27: reference point storage section
28: displaying image creating section
29: shift lever
31: symbol image
31A: symbol region
32: bird's eye view image
33: transparent region
33D: dead angle
34: underneath image

1. A large scaled dump truck comprising a display controller that is adapted to process image data taken by a plurality of cameras mounted around a body of the large scaled dump truck to create bird's eye view images and composite and display the bird's eye view images on a monitor device, wherein
the monitor device includes a screen for displaying a symbol image of a symbolized large scaled dump truck and the bird's eye view images,
the symbol image is divided into a transparent region for displaying an underneath image that corresponds to an under portion of the body which is rearward from a rear wheel of the large scaled dump truck, and a symbol region that is a region other than the transparent region, and
the screen is adapted to display:
first and second boundary lines that are formed respectively from a front right corner and a front left corner of the symbol image in a traveling direction of the large scaled dump truck toward preset positions on an outer edge of the screen at a front side of the traveling direction;
third and fourth boundary lines that are formed respectively from a right side point and a left side point on a boundary line between the transparent region and the symbol region in the traveling direction toward preset positions on the outer edge of the screen at a rear side of the traveling direction;
a right side region for displaying a bird's eye view image, where is partitioned with the first boundary line, the third boundary line, and a boundary line of the symbol region at a right side in the traveling direction;
a left side region for displaying a bird's eye view image, where is partitioned with the second boundary line, the fourth boundary line, and a boundary line of the symbol at a left side in the traveling direction; and
a rear region for displaying a bird's eye view image, where is partitioned with the third boundary line, the fourth boundary line, and the boundary line between the transparent region and the symbol region, and includes the transparent region.

2. The large scaled dump truck according to claim 1, wherein the underneath image is taken by a rear camera provided at a position that is higher than a height of a rear wheel of the large scaled dump truck and is rearward from the rear wheel.

3. The large scaled dump truck according to claim 2, wherein
the right side region for displaying a bird's eye view image is adapted to display a right side bird's eye view image that is taken by a right side camera provided at a right side of the body in the traveling direction,
the left side region for displaying a bird's eye view image is adapted to display a left side bird's eye view image that is taken by a left side camera provided at a left side of the body in the traveling direction, and
the rear region for displaying a bird's eye view image is adapted to display a rear side bird's eye view image that is taken by the rear camera.

4. The large scaled dump truck according to claim 3, wherein the display controller includes:
a view point conversion section that is adapted to convert the image data to upper view point to create the bird's eye images;
a superposing process section that is adapted to cause the underneath image to be transparent with a predetermined transparent ratio in the transparent region to process to superpose the underneath image in the transparent region;
a reference point storage section that is adapted to store, as reference points for forming the first to fourth boundary lines, the two corners of front left and front right of the symbol image in the traveling direction of the large scaled dump truck and two points of left side and right side on the boundary line between the transparent region and the symbol region in the traveling direction; and
an image composing section that is adapted to place the symbol image at a center and respectively arrange the right side bird's eye view image on the right side region for displaying a bird's eye view image, the left side bird's eye view image on the left side region for displaying a bird's eye view image, and the rear side bird's eye view image on the rear region for displaying a bird's eye view image, based on the reference points read out from the reference point storage section to create a composite image.

5. The large scaled dump truck according to claim 1, wherein the monitor device is provided in an operator's cab of the large scaled dump truck.
